(19) United States
(12) Patent Application Publication
(10) Pub. No.: US 2020/0032901 A1
(43) Pub. Date: Jan. 30, 2020

(54) FINAL DRIVE FOR A MOTOR VEHICLE

(71) Applicant: AUDI AG, Ingolstadt (DE)

(72) Inventor: Christian MEIXNER, Ingolstadt (DE)

(73) Assignee: AUDI AG, Ingolstadt (DE)

(21) Appl. No.: 16/337,586

(22) PCT Filed: Sep. 19, 2017
(86) PCT No.: PCT/EP2017/073684

§ 371 Date: Mar. 28, 2019

(30) Foreign Application Priority Data
Sep. 28, 2016 (DE) 10 2016 218 729.5

(51) Int. Cl. F16H 63/30

(52) U.S. Cl. CPC F16H 63/3069; F16H 2048/385

(57) ABSTRACT

A final drive for a motor vehicle, with a first input shaft, a second input shaft, a first output shaft and a second output shaft, the first input shaft being permanently coupled to the first output shaft by a first crown gear drive and the second input shaft being permanently coupled to the second output shaft by a second crown gear drive. The first input shaft and the second input shaft are arranged coaxially with each other and the first output shaft and the second output shaft extend in opposite directions starting from the respective crown gear drives, an axial plane extending the rotational axes of the input shafts and encloses a plane perpendicular to the axis plane with the rotational axes of the output shafts.

The invention relates to a final drive for a motor vehicle, with a first input shaft, a second input shaft, a first output shaft and a second output shaft, the first input shaft being permanently coupled to the first output shaft by means of a first crown gear drive and the second input shaft being permanently coupled to the second output shaft by means of a second crown gear drive.

The final drive is assigned to an axle of the motor vehicle, for example a front axle, but preferably to a rear axle of the motor vehicle. The final drive serves to transmit torque from a motor vehicle drive unit to the wheels of the motor vehicle. In other words, an operative connection between the drive unit of the motor vehicle and the axle or its wheels is established or at least can be established via the final drive. The drive unit is permanently coupled or at least can be coupled to the first input shaft and the second input shaft. For example, there is an operative connection between the drive unit and the two input shafts via a gear unit different from the final drive. For example, the gear unit can be embodied as a differential, in particular as an axle differential. The two input shafts can therefore comprise propeller shafts or can at least be coupled with propeller shafts, in particular permanently coupled.

For example, the two input shafts of the final drive are permanently coupled to the output shafts of the gear unit, in particular rigidly coupled. The two output shafts of the final drive are provided on the wheel side, i.e., with regard to torque flow, they are arranged on one side of the crown gear drive facing away from the drive unit. For example, the first output shaft is assigned to a first wheel of the axle and the second output shaft is assigned to at least a second wheel of the same axle, in particular permanently and/or rigidly coupled. However, it may of course be provided that the operative connection between the first output shaft and the first wheel and/or the operative connection between the second output shaft and the second wheel is at least temporarily interruptible. For this purpose, one clutch, for example a claw coupling, can be provided in each of the operative connections.

Within the final drive, the first input shaft is permanently coupled to the first output shaft and the second input shaft is permanently coupled to the second output shaft. The first crown gear drive and the second crown gear drive are used for this purpose. With the aid of the crown gear drives, the input shafts and the output shafts are arranged at an angle to each other. For example, it can be provided that the crown gear drives each have a hypoid offset, so that the output shafts are arranged offset in relation to the input shafts, in particular are skewed to these shafts, i.e., are arranged at a distance parallel to them. However, this results in a large installation space required for the final drive.

It is the object of the invention to propose a final drive for a motor vehicle, which has advantages over known final drives, in particular a reduced installation space requirement with concurrent reliable bearing of the crown gear drive.

This is achieved according to the invention with a final drive with the features of claim 1. It is provided that the first input shaft and the second input shaft are arranged coaxially with respect to each other and the first output shaft and the second output shaft extend in opposite directions, starting from the respective crown gear drive, wherein an axial plane accommodates the rotational axes of the input shafts and a plane perpendicular to the axial plane encloses an angle of at least 75° and at most 90° with the rotational axes of the output shafts, and that a first crown gear of the first crown gear drive is rigidly connected to the first output shaft and/or a second crown gear of the second crown gear drive is rigidly connected to the second output shaft is/are each mounted in a transmission housing of the axle transmission by means of a first radial bearing and a second radial bearing, which are arranged in an O arrangement relative to one another or are designed as fixed bearings and as floating bearings.

In total, this provides a special arrangement of the input shafts and the output shafts as well as a special bearing of at least one of the crown gears, namely the first crown gear and the second crown gear of the two crown gear drives. This arrangement, in turn, enables a special embodiment of the gearbox housing, which for example is made up of several parts. First, the two input shafts are arranged coaxial to each other. For example, the second input shaft runs in the first input shaft or vice versa. The two output shafts are essentially opposite each other, in particular in relation to the plane of symmetry, and extend in opposite directions, preferably in the direction of the corresponding wheel of the motor vehicle, starting from the respective crown gear drive.

Both the rotational axis of the first output shaft and the rotational axis of the second output shaft intersect, for example, the two rotational axes of the input shafts or the common rotational axis of the input shafts. In other words, it is provided that the rotational axes of the output shafts intersect the rotational axes of the input shafts, respectively. Accordingly, the crown gear drives can be embodied without hypoid offset. However, an embodiment with hypoid offset is also possible, in which at least the rotational axis of one of the output shafts does not intersect the rotational axes of the input shafts. In this case, however, the rotational axes of both output shafts preferably do not intersect the rotational axes of the input shafts. This results in an overall skewed arrangement of the rotational axes of the output shafts in relation to the rotational axes of the input shafts.

In addition, it is now provided that the (imaginary) axial plane should accommodate the rotational axes of the input shafts. The axial plane is essentially arranged horizontally in relation to the mounting position of the final drive. Accordingly, the plane perpendicular to the axial plane, which also accommodates the rotational axes of the input shafts, is available as a vertical plane, i.e., it is essentially perpendicular in the mounting position of the final drive. The plane perpendicular to the axial plane includes an angle of at least 75° and at most 90° between the rotational axes of the output shafts and the plane, viewed at least in section, in particular in cross-section in relation to the rotational axes of the input shafts.

Each rotational axis therefore includes an angle with the plane that fulfills the above requirements. The angles between the rotational axes and the plane can be identical or alternatively, different from each other. For example, the angle or angles is/are at least 75° and at most 90°. The preferred angle or angles is/are at least 80°, at least 85°, at least 86°, at least 87°, at least 88° or at least 89°, but never more than 90°. This means that the angle or angles can be exactly 90° or less than 90°.

In addition or alternatively, the plane perpendicular to the axial plane is present, viewed at least in section, in particular in cross-section in relation to the rotational axes of the input shafts, as the plane of symmetry for the rotational axes of the output shafts. In this case, the rotational axes of the output shafts are arranged or aligned symmetrically in relation to the plane of symmetry.

Now, the first crown gear is rigidly connected to the first output shaft and the second crown gear is rigidly connected to the second output shaft. The crown ring gear forms part of the first crown gear drive, the second crown gear forms part of the second crown gear drive. At least one of these crown gears, but preferably both crown gears, are now each supported by two radial bearings, namely the first radial bearing and the second radial bearing, in the gearbox housing of the final drive. The two radial bearings are arranged in an O arrangement to each other. Alternatively, they can also be embodied as fixed bearings and floating bearings. In the latter case, one of the radial bearings forms the fixed bearing and the other of the radial bearings the floating bearing. Such an arrangement and/or embodiment of the radial bearings enables reliable and compact support of the crown gear or crown gears on and/or in the gearbox housing.

Another embodiment of the invention provides that the rotational axes of the two input shafts and the rotational axes of the two output shafts lie in the axial plane. This represents a particularly advantageous alignment of the input shafts and the output shafts, which permits an extremely compact embodiment of the final drive. If both the input shafts and the output shafts are arranged in the axial plane, the above definition using the plane of symmetry may be omitted. This is no longer necessary for the definition of the axial plane.

Another particularly preferred embodiment of the invention is that a bearing element is arranged in the gearbox housing, which has a first bearing protrusion and a second bearing protrusion, wherein the first crown gear of the first crown gear drive is mounted on the first bearing protrusion and the second crown gear of the second crown gear drive is mounted on the second bearing protrusion. To make the final drive particularly compact, the bearing element is arranged in the gearbox housing. The bearing element has the two bearing protrusions, namely the first bearing protrusion and the second bearing protrusion. The bearing protrusions serve to support the crown gears of the two crown gear drives. To this respect, the first crown gear is mounted on the first bearing protrusion and the second crown gear is mounted on the second bearing protrusion.

The bearing is preferably designed directly so that the respective crown gear is seated on the corresponding bearing protrusion. Alternatively, however, an indirect support can be provided in which, for example, the crown gears are supported on the bearing protrusion via the respective output shaft. In such an embodiment, the output shaft is supported directly on or at the bearing protrusion. The support of the respective crown gear is only provided indirectly via the output shaft. For example, the crown gear can be arranged at a distance from the bearing protrusion in the axial direction in relation to its rotational axis or the rotational axis of the output shaft. The first crown gear is rigidly connected to the first output shaft or, alternatively, designed such that it forms one piece with it. This can analogously be provided for the second crown gear and the second output shaft, as well.

The bearing element is a device designed separately from the gearbox housing. The gearbox housing and the bearing element are therefore manufactured separately from each other, first, and then the bearing element is arranged on or in the gearbox housing. The bearing element is preferably arranged centrally in the gearbox housing, especially centrally in relation to the rotational axes of the two input shafts. In particular, the rotational axes of the two input shafts run through the bearing element, thus intersecting it. To enable a simple arrangement of the bearing element in the gearbox housing, it is preferably embodied in several parts and has, for example, a first housing shell and a second housing shell. The two bearing protrusions, for example, are round in diameter in relation to their respective longitudinal center axis and preferably start from a central dome of the bearing element in axial direction. On their end facing away from the central dome, the bearing protrusions are preferably unattached.

In a further development of the invention provides that the first radial bearing and the second radial bearing for the bearing of the respective crown gear are arranged on the first bearing protrusion or the second bearing protrusion. The two radial bearings, i.e., the first radial bearing and the second radial bearing, are preferably arranged on the first bearing protrusion if they are used to support the first crown gear and on the second bearing protrusion if they are intended to support the second crown gear. The arrangement of the radial bearings on the bearing protrusion means that they sit with their inner rings on the respective bearing protrusion. This means that their inner rings completely surround the bearing protrusion in circumferential direction and preferably lie against it, at least partly continuous, in particular completely continuous in circumferential direction. Conversely, this means that the outer rings of the radial bearings engage with the respective crown gear. This means that the crown gear on the gearbox housing is preferably fully supported via the corresponding bearing protrusion, so that the crown gear is only supported indirectly, i.e., via the respective bearing protrusion, on the gearbox housing.

As part of a further embodiment of the invention, it is provided that the first radial bearing and the second radial bearing rest against an inner bearing surface of the respective crown gear. The inner bearing surface is formed by an area of the inner circumferential surface of the crown gear. In this respect, the crown gear has a recess which is coaxial with its rotational axis or the rotational axis of the corresponding output shaft. Both radial bearings now engage in this recess. For this purpose, the respective bearing protrusion preferably protrudes into the corresponding crown gear in axial direction. For example, the bearing protrusion penetrates a face of the crown gear, in particular a face of the crown gear facing the bearing element.

As part of a further embodiment of the invention, it is provided that the first bearing protrusion and the second bearing protrusion originate from a central dome of the bearing element. In this respect, the central dome is located between the two bearing protrusions, which originate from it from opposite sides of the central dome. For example, the central dome is arranged approximately in the center of the gearbox housing, preferably in the center in relation to the rotational axes of the input shafts. The rotational axes of the input shafts preferably run at least through the bearing element, but in particular through the central dome.

In a further embodiment the invention, the second radial bearing is fixed in the direction away from the central dome by means of a fastener. In other words, the second radial bearing is fixed axially outwards using the fastener. A circlip, for example, is used as a fastener. The second radial bearing is preferably located between the fastener and the second crown gear or an axial bearing protrusion of the crown gear or the first output shaft. The second radial bearing is preferably in permanent contact with the fastener, on the one hand, and with the axial bearing protrusion, on the other hand. The axial bearing protrusion extends inwards in radial direction and serves as a stop for the second radial bearing, in particular for the outer ring of the second radial bearing.

A further development of the invention provides that the bearing element, in particular the central dome, is attached to the gearbox housing, whereby the first radial bearing and the second radial bearing are connected to the gearbox housing only via the bearing element. The bearing element is arranged in the gearbox housing and fastened to it. For example, the bearing element at least partially rests against the gearbox housing. This applies to the central dome, in particular. The bearing element is preferably fastened to the gearbox housing by means of at least one screw. For example, the gearbox housing is designed in several parts and therefore has a first housing shell and a second housing shell. The two housing shells are designed separately from each other and preferably lie against each other in a contact plane which lies in the axis plane or parallel to it.

It may now be provided that the bearing element is attached to the first housing shell and to the second housing shell, in particular on opposite sides of the contact plane or by means of at least one screw, the longitudinal center axis of which is angled and/or perpendicular to the contact plane. It may also be provided that the bearing element is attached to the first housing shell and/or the second housing shell on both sides of an imaginary plane, which is arranged vertically on the contact plane and accommodates an intersection of the rotational axes of the output shafts with the rotational axes of the input shafts.

The radial bearings arranged on the first bearing protrusion or the second bearing protrusion are now connected to the gearbox housing exclusively via the bearing element. This, in turn, means that the output shaft, which is supported by the radial bearings, is also connected to or supported on the gearbox housing exclusively via the radial bearings and finally exclusively via the bearing element.

In a further embodiment of the invention, the rotational axes of the first output shaft and the second output shaft coincide with a common rotational axis of the output shafts. The two output shafts therefore have a common rotational axis. The rotational axes of the output shafts therefore only intersect the rotational axes of the drive shafts at a single point and not at several spaced points. It preferably follows that the rotational axes of the two input shafts and the rotational axes of the two output shafts are in the axial plane. This has already been pointed out above.

Finally, in a further embodiment of the invention, it may be provided that the first bearing protrusion and/or the second bearing protrusion has a first region with a first diameter and a second region with a second diameter different from the first diameter, wherein the first radial bearing is arranged on the first region and the second radial bearing is arranged on the respective bearing protrusion in the second region. The first diameter is preferably larger than the second diameter, whereby this can of course also be the other way around. The first region preferably borders directly on the central dome but is always located on the side of the second region facing the central dome. The two regions, i.e., the first region and the second region, preferably adjoin each other directly in axial direction in relation to the rotational axis of the output shaft mounted on the respective bearing protrusion.

Because the first radial bearing in the first region and the second radial bearing in the second region rest on the respective bearing protrusion, the inner ring of the first radial bearing has a different, in particular a larger diameter than the inner ring of the second radial bearing. The radial bearings are preferably of the same size in radial direction, so that, analog to the inner rings, the outer ring of the first radial bearing has a larger diameter than the outer ring of the second radial bearing. In other words, the difference between the diameters of the outer rings and the diameters of the inner rings is identical for the two radial bearings. However, the radial bearings can of course be chosen such that the diameter difference between the inner rings and outer rings varies. For example, the inner rings have different diameters, while the outer rings have the same diameter, or vice versa.

The invention is explained in more detail below using the examples shown in the drawing, without any limitation of the invention.

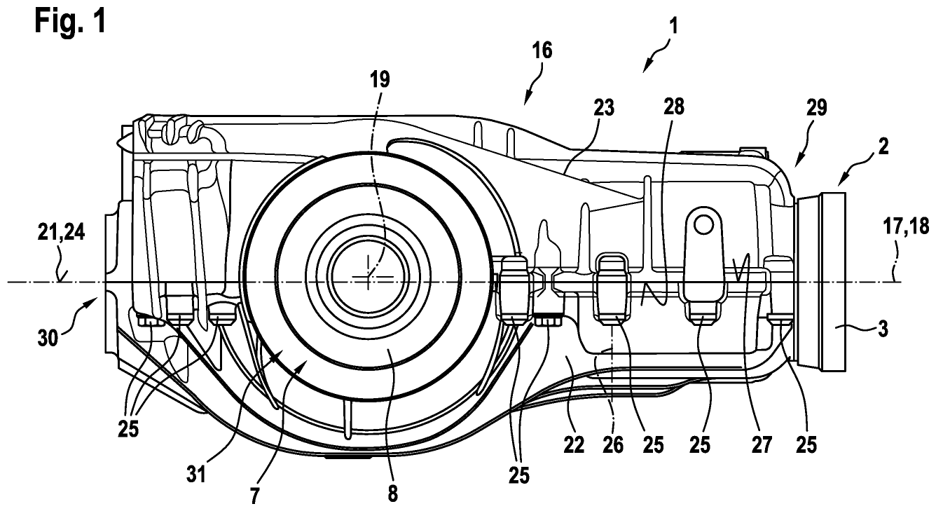

FIG. 1 shows a schematic side view of a final drive for a motor vehicle,

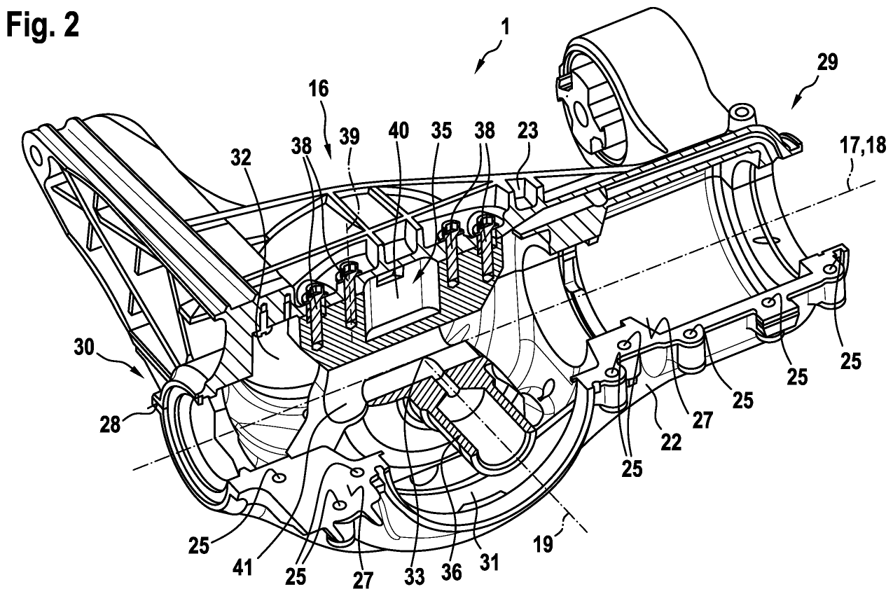

FIG. 2 shows a schematic sectional view through a gearbox housing and a bearing element arranged in the gearbox housing,

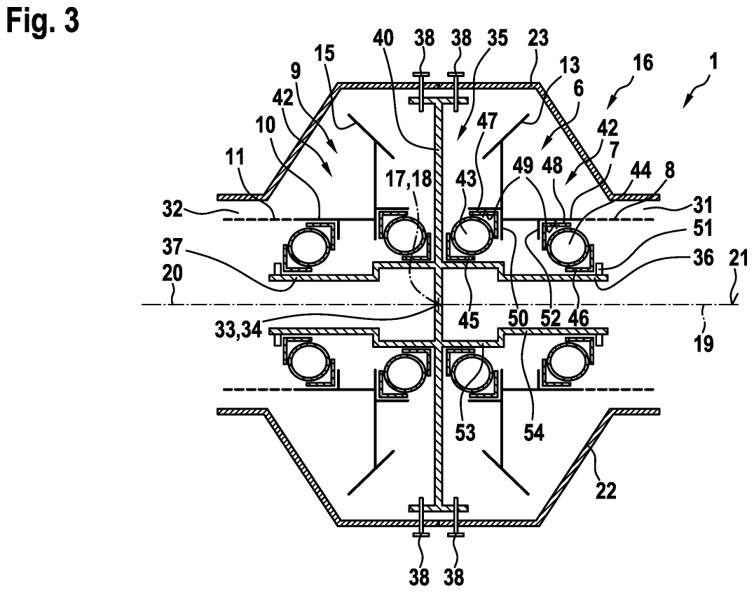

FIG. 3 shows a schematic view of the final drive in a first embodiment,

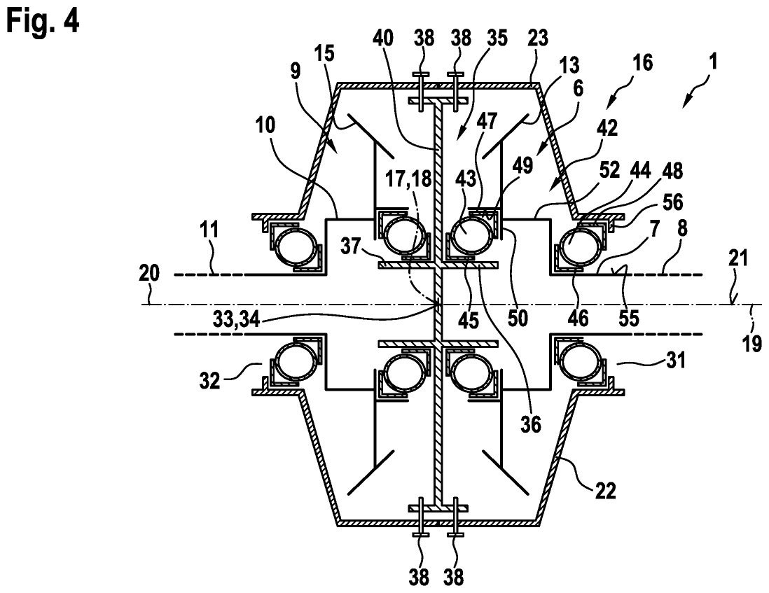

FIG. 4 shows a schematic view of a second embodiment of the final drive,

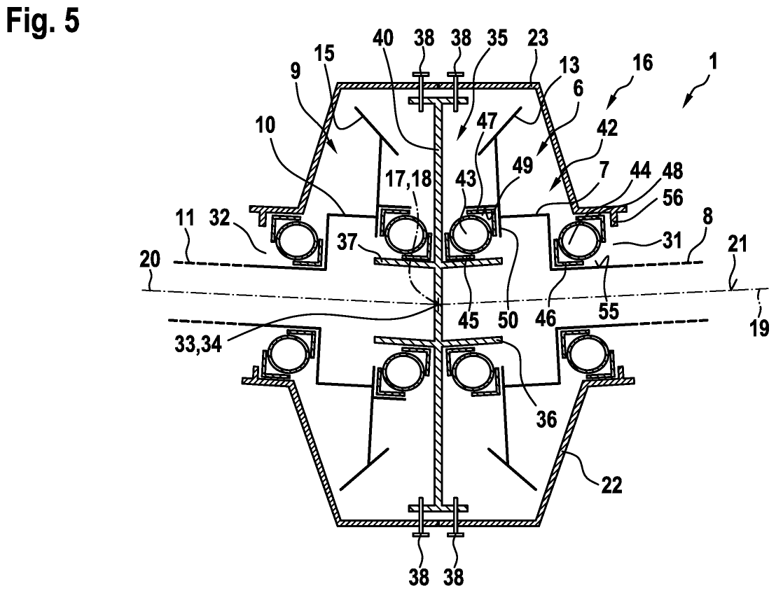

FIG. 5 shows a schematic view of a first version of a third embodiment of the final drive, and

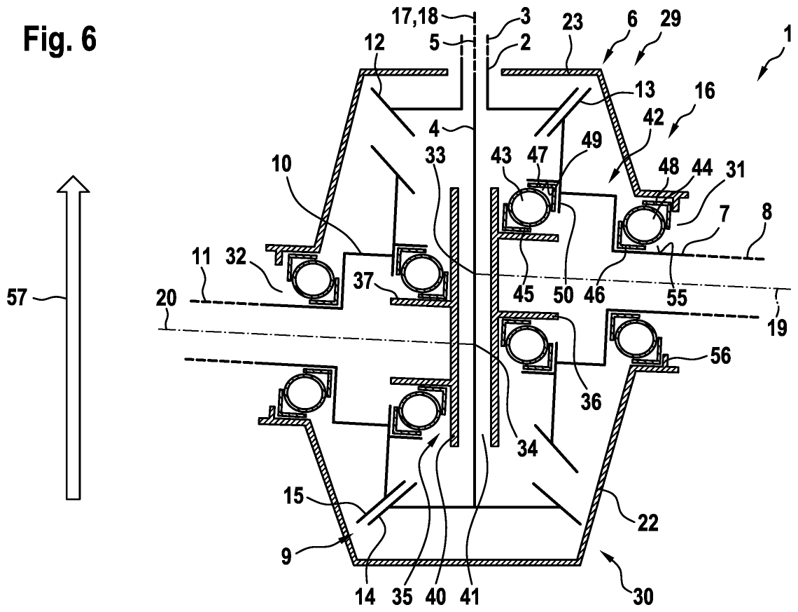

FIG. 6 shows a schematic view of a second version of the third embodiment of the final drive.

FIG. 1 shows a schematic side view of a final drive 1 for a motor vehicle. This has a first input shaft 2, of which a connecting flange 3 is shown here. Coaxial to the first input shaft 2, a second input shaft 4 is arranged, which is not visible here. Here, the first input shaft 2 is designed as a hollow shaft and the second input shaft 4 is arranged and/or mounted in the first input shaft 2. The second input shaft 4 has a connecting flange 5, which is preferably arranged in the connecting flange 3 of the first input shaft 2. The first input shaft 2 is permanently coupled to a first output shaft 7 by means of a first crown gear drive 6. The first output shaft 7 has a connecting flange 8, which is visible here. Similarly, the second input shaft 4 is permanently coupled to a second output shaft 10, which is not visible here, by means of a second crown gear drive 9, which shaft has a connecting flange 11.

The first crown gear drive 6 consists of a crown gear 12 rigidly and permanently coupled to the first input shaft 2 and a crown gear 13 meshing with the crown gear 12 and permanently and rigidly coupled to the first output shaft 7. Analogously, the second crown gear drive 9 has a crown gear 14 rigidly and permanently coupled to the second input shaft 4 and a crown gear 15 meshing with the ring gear 14 and rigidly and permanently coupled to the second output shaft 10. The crown gear drives 6 and 9 and correspondingly, the crown gears 12, 13, 14 and 15, are arranged, in particular completely, in a gearbox housing 16 of the final drive 1. In other words, the gearbox housing 16 preferably completely encloses the crown gears 6 and 9.

It has already been pointed out that the first input shaft 2 and the second input shaft 4 are arranged coaxially with each other, the second input shaft 4 being in the first input shaft 2. The input shafts 2 and 4 therefore have common rotational axes 17 and 18. The first output shaft 7 and the second output shaft 10 now extend in opposite directions starting from the respective crown gear drive 6 and 9, respectively. In the exemplary embodiment shown here, the first output shaft 7 thus extends out of the drawing plane, while the second output shaft 10 extends into the drawing plane. A rotational axis 19 of the first output shaft 7 or of each connecting flange 8 is arranged slightly obliquely in vertical direction and intersects the rotational axes 17 and 18. The same applies to a rotational axis 20 of the second output shaft 10 or its connecting flange 11, which is not visible here.

The input shafts 2 and 4 or their rotational axes 17 and 18 are located in an axis plane 21, which is basically arranged horizontally. In other words, an imaginary plane is vertical on axis plane 21, which is provided as a plane of symmetry for the rotational axes 19 and 20 of the output shafts 7 and 10, when viewed in section, especially in cross-section, in relation to the rotational axes 17 and 18. The rotational axes 19 and 20 are arranged and aligned symmetrically to this imaginary plane, which can also be called vertical plane due to the horizontal arrangement of the axis plane 21.

Because the imaginary plane serves as a symmetry plane for the rotational axes 19 and 20, the rotational axes 19 and 20 intersect both the symmetry plane and the axis plane at the same angle. In other words, the rotational axis 19 is at a first angle in relation to axis plane 21 or plane of symmetry, and the rotational axis 20 is at a second angle in relation to axis plane 21 or plane of symmetry, both angles being equal. In general, the rotational axes 19 and 20 intersect the axis plane 21. It may also be provided that the rotational axes 19 and 20 are completely in the axis plane 21.

To enable a space-saving embodiment of the final drive 1, the gearbox housing 16 is embodied in several parts and has a first housing shell 22 and a second housing shell 23, which are embodied separately from each other and rest against each other in a contact plane 24, which lies in axis plane 21 or parallel to it. The first housing shell 22 and the second housing shell 23 are screwed together by means of at least one screw 25, in the exemplary embodiment shown here by means of a plurality of screws 25. At least one of the screws 25, but preferably all of the screws 25, now has/have a longitudinal center axis 26 which is angled in relation to the contact plane 24, i.e., intersects it at a certain angle.

In this respect, it is not provided that the screw 25 or its longitudinal center axis 26 is arranged parallel to the contact plane 24 or that the longitudinal center axis 26 is located in the contact plane 24. Instead, the longitudinal center axis 26 is particularly preferred as being perpendicular to the contact plane 24. In addition, it is preferably provided that at least one of the screws 25 is penetrated by contact plane 24, i.e., intersected by contact plane 24.

For the arrangement of the screw 25, this means that it is located on the side of the gearbox housing 16 and not on a separate mounting flange, which would be provided on an upper side or a lower side of the gearbox housing 16 for attaching shells 22 and 23 to each other. Such a mounting flange is simply not provided for in the advantageous embodiment of the final drive 1 described here. With such an embodiment, the installation space required in vertical direction, i.e., in the plane of symmetry, can be significantly reduced in comparison with other final drives 1.

The first housing shell 22 has a plane first contact surface 27 at contact plane 24 and the second housing shell 23 has a plane second contact surface 28 at contact plane 24. After the housing shells 22 and 23 have been fitted, the two contact surfaces 27 and 28 lie flat against each other, especially over their entire surface. Full-surface arrangement means that the entire first contact surface 27 is in contact with the entire second contact surface 28. Each of the contact surfaces 27 and 28 fully covers the other contact surface 28 and 27, respectively.

The screw 25 now penetrates both the first contact surface 27 and the second contact surface 28. It therefore engages both the first housing shell 22 and the second housing shell 23 to fasten them together. In the exemplary embodiment shown here, it is provided that the first contact surface 27 extends in the direction of the rotational axes 17 and 18 from one end 29 of the gearbox housing 16 to its other end 30. In addition or alternatively, this applies to the second contact surface 28. In a particularly preferred embodiment, both the first contact surface 27 and the second contact surface 28 extend, on the one hand, to the end of 29 and, on the other hand, to the end of 30.

However, the contact surfaces 27 and 28 may be interrupted between the ends 29 and 30. In the exemplary embodiment shown here, this is the case for both contact surfaces due to a first outlet recess 31 for the first output shaft 7 or its connecting flange 8, and a second outlet recess 32 for the second output shaft 10 or its connecting flange 11. To this respect, the first output shaft 7 penetrates or is arranged in the first outlet recess 31, while the second output shaft 10 penetrates or is arranged in the second outlet recess 32.

It is particularly preferred that the outlet recesses 31 and 32 are each embodied in equal parts in the housing shell 22 and the second housing shell 23. At least, however, each of the outlet recesses 31 and 32 is at least partially present in the first housing shell 22 and at least partially in the second housing shell 23. The contact surfaces 27 and 28 each have two partial surfaces which, seen in axial direction in relation to the rotational axes 17 and 18, are located on opposite sides of the outlet recesses 31 and 32.

FIG. 2 shows a schematic partial section of a part of the final drive 1. Input shafts 2 and 4 as well as output shafts 7 and 10 are not shown. This also applies to the crown gear drives 6 and 9. In principle, however, reference is made to the above remarks. Here, it is clearly visible that the rotational axis 19 intersects the rotational axes 17 and 18 at an intersection point 33. Analogously, this also applies to the rotational axis 20 at an intersection point 34 not shown here, which may coincide with the intersection point 33.

Furthermore, it can now be seen that a bearing element 35 is arranged in the gearbox housing 16 in a preferred embodiment of the final drive 1. This has a first bearing protrusion 36 as well as a second bearing protrusion 37, which is located opposite this protrusion and is not visible here. The first crown gear 13 rigidly connected to the first output shaft 7 is pivoted on the first bearing protrusion 36, and the crown gear 15 of the second crown gear drive 9 rigidly connected to the second output shaft 10, is pivoted on the second bearing protrusion 37. The first bearing protrusion 36 protrudes in the direction of the first outlet recess 31, in particular, it protrudes into it or even penetrates it in the direction of the rotational axis 19. Conversely, the second bearing protrusion 37 protrudes in the direction of the second outlet recess 32. It can also protrude into it or even penetrate it in the direction of the rotational axis 20.

The bearing element 35 is now attached to the first housing shell 22, on the one hand, and to the second housing shell 23, on the other hand. The attachment is carried out with at least one screw 38, preferably with several screws 38. This can only be seen here for the attachment of bearing element 35 to the second housing shell 23. However, the corresponding embodiments are preferably transferable to the attachment of the bearing element 35 to the first housing shell 22. It can be seen that the screw 38 or the screws 38 each have a longitudinal center axis 39. The screw 38 or its longitudinal center axis 39 is now angled in relation to contact plane 24 (not shown here). In particular, it is perpendicular to contact plane 24. This means, in consequence, that the longitudinal center axis 39 of the screw 38 is preferably aligned parallel to the longitudinal center axis 26 of the screw 25.

To support the bearing element 35 on the gearbox housing 16, the screw 38 engages in a central dome 40 of the bearing element 35. The bearing protrusions 36 and 37 branch off from the central dome 40 on opposite sides of the plane of symmetry. Furthermore, a passage recess 41 for receiving the second input shaft 4 can be formed in the central dome 40, in particular between the bearing protrusions 36 and 37. Preferably, the second input shaft 4 completely penetrates the bearing element 35 in this respect, in particular its passage recess 41 in the axial direction in relation to the rotational axes 17 and 18.

The crown gear drives 6 and 9 are preferably embodied such that the crown gears 12 and 14 connected to the input shafts 2 and 4 are on opposite sides of the bearing element 35, i.e., on opposite sides of a plane perpendicular to the rotational axes 17 and 18. In particular, the crown gear 12 is completely on one side of this plane and the crown gear 14 is completely on the opposite side of the plane. The bearing element 35 is preferably embodied in one piece and/or consists of uniform material. For example, it consists of the same material as the housing shells 22 and 23. The use of bearing element 35 permits a particularly compact embodiment of the axle drive 1, especially in vertical direction.

FIG. 3 shows a schematic sectional view of the final drive 1, i.e., a cross-section in relation to the rotational axes 17 and 19, whereby the sectional plane is perpendicular to the rotational axes 17 and 18 and preferably accommodates the rotational axes 19 and 20. The viewing direction in the cross-section is in the direction of the end 29. Input shafts 2 and 4 are not shown. It can be seen that each of the crown gears 13 and 15 and each of the output shafts 7 and 10 is supported in the gearbox housing 16 by means of a bearing arrangement 42. The bearing arrangement 42 for the crown gears 13 and 15 and the corresponding output shafts 7 and 10 are designed analogously, but in particular inverted. The bearing arrangement 42 for the crown gear 13 or the first output shaft 7 is described in more detail below. However, the designs can always be transferred to the bearing arrangement 42 for the crown gear 15 or the second output shaft 10.

The bearing arrangement 42 has a first radial bearing 43 and a second radial bearing 44. These are arranged in an O arrangement to each other. Alternatively, they can also be embodied as fixed bearings and floating bearings. In the latter case, one of the radial bearings 43 and 44 forms the fixed bearing and the other of the radial bearings 43 and 44 the floating bearing. In the following, however, the O-arrangement shown here will be discussed in more detail. However, the designs can always be transferred to the embodiment of the radial bearings 43 and 44 as fixed bearings and floating bearings. The radial bearings 43 and 44 are preferably designed as rolling bearings, especially as ball bearings.

The radial bearings 43 and 44 are both arranged on the first bearing protrusion 36. This means that they sit with their inner rings 45 and 46 on the first bearing protrusion 36. In contrast, the outer rings 47 and 48 of the radial bearings 43 and 44 are arranged in the crown gear 13 and/or the first output shaft 7. Accordingly, the outer rings 47 and 48 are in contact with an inner bearing surface 49 of the crown gear 13 and the first output shaft 7 respectively. It is provided that the first radial bearing 43 is supported in axial direction in relation to the rotational axis 19 on the central dome 40 of the bearing element 35. In other words, the first radial bearing 43 is arranged in axial direction in relation to the rotational axis 19 between the central dome 40 and the crown gear 13 or an axial bearing projection 50 of the crown gear 13. In particular, the radial bearing 43 is in permanent contact with the central dome 40 and, on the other hand, in permanent contact with the axial bearing protrusion 50.

The second radial bearing 44 is preferably fixed in the axial outward direction, i.e., in the direction away from the central dome 40, by means of a fastener 51. For example, a circlip or similar is used as a fastener 51. In particular, the fastener 51 is detachable. The radial bearing 44 is preferably located between the fastener 51 and the crown gear 13 or an axial bearing protrusion 52 of the crown gear 13 or the first output shaft 7. The second radial bearing 44 is preferably in permanent contact with the fastener 51, on the one hand, and with the axial bearing protrusion 52, on the other hand.

The axial bearing protrusions 50 and 52 can be arranged differently from each other and, in particular, spaced apart in the axial direction. However, the axial bearing protrusions 50 and 52 can also be embodied as a common axial bearing protrusion, with the first radial bearing 43 on one side and the second radial bearing 44 on the axially opposite side of this common axial bearing protrusion. It becomes apparent that the bearing arrangement 42, i.e., both the first radial bearing 43 and the second radial bearing 44, are only attached to the gearbox housing 16 via the bearing element 35. The radial bearings 43 and 44 therefore only engage with the gearbox housing 16 via the bearing element 35.

It also becomes apparent that the first bearing protrusion 36 has a first region 53 and a second region 54, which differ in diameter. For example, the first bearing protrusion 36 has a first diameter in the first region 53 and a second diameter in the second region 54, the first diameter being larger than the second diameter. The first region 53 preferably borders directly on the central dome 40 but is always located on the side of the second region 54 facing the central dome 40. The two regions 53 and 54 preferably adjoin each other directly in axial direction in relation to the rotational axis 19.

The first radial bearing 43 now sits in the first region 53 and the second radial bearing 44 sits in the second region 54 on the first bearing protrusion 36. In this respect, the inner ring 45 has a larger diameter than the inner ring 46. The radial bearings 43 and 44 are preferably of the same size in radial direction, so that, analog to the inner rings 45 and 46, the outer ring 47 has a larger diameter than the outer ring 48. However, the radial bearings 43 and 44 can, of course, be chosen such that the diameter difference between the inner rings 45 and 46 and outer rings differs from the diameter difference of the outer rings 47 and 48. For example, the inner rings 45 and 46 are embodied with different diameters, while the outer rings 47 and 48 have the same diameter.

FIG. 4 shows a second embodiment of the final drive 1, again in a sectional view. In principle, reference is made to the above explanations and only the differences are discussed below. These are due to the fact that the radial bearings 43 and 44 of bearing arrangement 42 are now arranged in tandem with each other. Alternatively, the radial bearings 43 and 44 could also be arranged in an X arrangement or—as already explained above—the radial bearings 43 and 44 could be embodied as fixed and floating bearings. The tandem arrangement is described in more detail below. However, the designs can be transferred to the X arrangement and the embodiment as fixed bearing and floating bearing.

The first radial bearing 43 is arranged in the same way as the first embodiment of the final drive 1. Accordingly, it sits with its inner ring 45 on the first bearing protrusion 36. In axial direction, it is preferably supported by the central dome 40, on the one hand, and by the axial bearing protrusion 50, on the other hand. However, there are differences with regards to the second radial bearing 44. This is located with its inner ring 45 on an outer bearing surface 55 of the crown gear 13 or the first output shaft 7. While the first radial bearing 43 engages the crown gear 13 or the output shaft 7, the second radial bearing 44 encompasses the crown gear 13 or the output shaft 7. Consequently, the first bearing protrusion 36 may be shorter and may have a uniform diameter. The fastener 51 can also be omitted.

The second radial bearing 44 engages the crown gear 13 or output shaft 7, on the one hand, and the gearbox housing 16 directly, on the other hand, in particular both housing shells 22 and 23. The axial bearing projection 52 is now formed by a contact shoulder of the crown gear 13 or the output shaft 7. This may again be demonstrated by a change in diameter. In order to fix the second radial bearing 44 in the axial direction in relation to the gearbox housing 16, at least to the outside, the gearbox housing 16 also has an axial bearing protrusion 56. This is preferably embodied both on the first housing shell 22 and on the second housing shell 23. The second radial bearing 44 is now located between the axial bearing protrusion 52 and the axial bearing protrusion 56 in the axial direction, in relation to the rotational axis 19. It is particularly preferable that it is in permanent contact with the axial bearing protrusion 52, on the one hand, and with the axial bearing protrusion 56, on the other hand.

FIG. 5 shows a first variation of a third embodiment of the final drive 1. Again, a schematic cross-sectional representation is shown in accordance with the explanations above. Bearing arrangement 42 is analog to the second embodiment described above. However, a bearing arrangement 42 according to the first embodiment can also be used. In this regard, reference is made to the above explanations. Only the differences with respect to the first two embodiments will be discussed below. These are due to the fact that the crown gears 13 and 15 and thus the rotational axes 19 and 20 do not run parallel to each other but are angled against each other instead.

This means that the rotational axes 19 and 20 continue to intersect the rotational axes 17 and 18 at the intersection points 33 and 34, whereby the intersection points 33 and 34 may coincide. Generally speaking, the rotational axes 19 and 20 intersect both rotational axes 17 and 18, respectively. The rotational axes 19 and 20 can additionally intersect each other or alternatively be arranged obliquely to each other, in particular with parallel spacing. In a first version shown here, the rotational axes 19 and 20 intersect. Here, the rotational axes 19 and 20 are angled at the same angle to the axis plane 21 and the contact plane 24, respectively, so that the plane perpendicular to the contact plane 24 and receiving the rotational axes 17 and 18 serves as the plane of symmetry for the rotational axes 19 and 20.

FIG. 6 shows a second variation of the third embodiment. This shows a sectional view of the final drive, namely a longitudinal view of the rotational axis 17 and 18. The sectional plane is selected such that the view is towards the first housing shell 22. Reference is expressly made to the above explanations. In addition to these, it can now be clearly seen here that the crown gears 12 and 14 of the crown gear drives 6 and 9 are arranged on opposite sides of bearing element 35. As already explained above, the second input shaft 4 penetrates the bearing element 35 for this purpose, in particular penetrating the passage recess 41. The direction of travel of a motor vehicle to which the final drive 1 is assigned is indicated by the arrow 57. In addition to or as an alternative to the first version described above, in which the rotational axes 19 and 20 are angled in relation to the axis plane, it can now be provided that the rotational axes 19 and 20 are also offset from each other in the axial direction in relation to the rotational axes 17 and 18. For example, the crown gear drives 6 and 9 are embodied such that there is a taper angle which is different from 90°. In contrast, and within the scope of the embodiments described above and the first version, the taper angle is preferably equal to 90°. The displacement of the rotational axes 19 and 20 in axial direction against each other results in two intersection points 33 and 34 spaced apart from each other.

The described final drive 1 enables an extremely compact embodiment. This applies, in particular, if a further gear unit, in particular a differential, preferably an axle differential, is arranged on the side of the input shafts 2 and 4 facing away from the final drive 1. The final drive 1 is therefore only used to establish permanent connections between the first input shaft 2 and the first output shaft 7, on the one hand, and the second input shaft 4 and the second output shaft 10, on the other hand.

1-10. (canceled)

11. A final drive for a motor vehicle, comprising:
a first input shaft, a second input shaft, a first output shaft and a second output shaft, the first input shaft being permanently coupled to the first output shaft by a first crown gear drive and the second input shaft being permanently coupled to the second output shaft by a second crown gear drive, wherein the first input shaft and the second input shaft are arranged coaxially with each other and the first output shaft and the second output shaft extend in opposite directions starting from the respective crown gear drives, an axial plane enclosing the rotational axes of the input shafts and a plane perpendicular to the axis plane with the rotational axes of the output shafts including an angle of at least 75° and at most 90°, respectively, and in that a first crown gear of the first crown gear drive, which is rigidly connected to the first output shaft and/or a second crown gear of the second crown gear drive, which is rigidly connected to the second output shaft, is/are each mounted in a gearbox housing of the final drive by a first radial bearing and a second radial bearing, which are arranged in an O arrangement to one another or are embodied as fixed bearings and as floating bearings.

12. The final drive according to claim 11, wherein the rotational axes of the two input shafts and the rotational axes of the two output shafts lie in the axial plane.

13. The final drive according to claim 11, wherein a bearing element, which has a first bearing protrusion and a second bearing protrusion, is arranged in the gearbox housing, the first crown gear of the first crown gear drive being mounted on the first bearing protrusion and the second crown gear of the second crown gear drive being mounted on the second bearing protrusion.

14. The final drive according to claim 11, wherein the first radial bearing and the second radial bearing for supporting the respective crown gear are arranged on the first bearing protrusion or the second bearing protrusion.

15. The final drive according to claim 11, wherein the first radial bearing and the second radial bearing are in contact with an inner bearing surface of the respective crown gear.

16. The final drive according to claim 11, wherein the first bearing protrusion and the second bearing protrusion originate from a central dome of the bearing element.

17. The final drive according to claim 11, wherein the first radial bearing is supported on the central dome in the axial direction in relation to a rotational axis of the respective crown gear.

18. The final drive according to claim 11, wherein the second radial bearing is fixed axially in the direction remote from the central dome by means of a fastener.

19. The final drive according to claim 11, wherein the bearing element, in particular the central dome, is fastened to the gearbox housing, the first radial bearing and the second radial bearing being connected to the gearbox housing only via the bearing element.

20. The final drive according to claim 11, wherein the first bearing protrusion and/or the second bearing protrusion has/have a first region with a first diameter and a second region with a second diameter different from the first diameter, the first radial bearing being arranged in the first region and the second radial bearing being arranged in the second region on the respective bearing protrusion.

21. The final drive according to claim 12, wherein a bearing element, which has a first bearing protrusion and a second bearing protrusion, is arranged in the gearbox housing, the first crown gear of the first crown gear drive being mounted on the first bearing protrusion and the second crown gear of the second crown gear drive being mounted on the second bearing protrusion.

22. The final drive according to claim 12, wherein the first radial bearing and the second radial bearing for supporting the respective crown gear are arranged on the first bearing protrusion or the second bearing protrusion.

23. The final drive according to claim 13, wherein the first radial bearing and the second radial bearing for supporting the respective crown gear are arranged on the first bearing protrusion or the second bearing protrusion.

24. The final drive according to claim 12, wherein the first radial bearing and the second radial bearing are in contact with an inner bearing surface of the respective crown gear.

25. The final drive according to claim 13, wherein the first radial bearing and the second radial bearing are in contact with an inner bearing surface of the respective crown gear.

26. The final drive according to claim 14, wherein the first radial bearing and the second radial bearing are in contact with an inner bearing surface of the respective crown gear.

27. The final drive according to claim 12, wherein the first bearing protrusion and the second bearing protrusion originate from a central dome of the bearing element.

28. The final drive according to claim 13, wherein the first bearing protrusion and the second bearing protrusion originate from a central dome of the bearing element.

29. The final drive according to claim 14, wherein the first bearing protrusion and the second bearing protrusion originate from a central dome of the bearing element.

30. The final drive according to claim 15, wherein the first bearing protrusion and the second bearing protrusion originate from a central dome of the bearing element.
